(19) United States
(12) Patent Application Publication
(10) Pub. No.: US 2004/0169142 A1
(43) Pub. Date: Sep. 2, 2004

(54) Method for analyzing organic material per microscopic area, and device for analysis per microscopic area

(76) Inventors: Mikihiro Yamanaka, Souraku-gun (JP); Jun Kudo, Nara-shi (JP)

Correspondence Address: Edwards & Angell, LLP, P. O. Box 55874, Boston, MA, 02205, US

(21) Appl. No.: 10/788,163

(22) Filed: Feb. 25, 2004

(30) Foreign Application Priority Data
Feb. 25, 2003 (JP) JP NO.2003-047743
Dec. 22, 2003 (JP) JP NO.2003-425515

(51) Int. Cl. G01N 23/00

(52) U.S. Cl. 250/310

(57) ABSTRACT

Provided is a method for evaluating an organic material in the order of nanometers. According to the present invention, suggested are a device and a method for evaluating an organic material in the order of nanometers, which have not been established in the prior art. In particular, information on energy in transition processes between electron energy levels in an organic material can be obtained with a spatial resolution power of several nanometers or less from the surface direction thereof or the cross-sectional direction thereof. The present invention can also be applied to evaluation of the interface state generated when different materials are jointed to each other. For example, the gradient of the potential or the electric charge state in the interface between an electrode and an organic layer in a semiconductor organic material or an organic luminous device can be evaluated. On the basis of the results, a band diagram of this element can be prepared. Consequently, in the element, the expression of a very high function can be realized.

### CROSS-REFERENCE TO RELATED APPLICATION

This application is related to Japanese Patent Application No. 2003-047743 filed on Feb. 25th in 2003, and No. 2003-425515 filed on Dec. 22nd in 2003. The priority of each application is claimed under 35 USC § 119, and the disclosure of each application is incorporated by reference in its entirety.

### BACKGROUND OF THE INVENTION

1. Field of the Invention

The present invention relates to a new method for analyzing an organic material (the category of which includes a device using an organic material) and, more specifically, to a method for analyzing an organic material locally in the unit of a microscopic area in the order of nanometers (10⁻⁹ m).

The present invention establishes a new method for analyzing an organic material, the method being able to evaluate the transition energy of an organic material, such as an organic EL material, the electric charge state thereof, the interface between the organic material and a different material, or the like; and the method being able to be used for new application and development of organic materials.

2. Description of the Related Art

Hitherto, properties about molecular orbitals, such as optical transition energy, of organic materials, have been evaluated, using ultraviolet-visual spectroscope (UV-Vis), X-ray photoelectron spectroscope (XPS), ultraviolet photoelectron spectroscope (UPS) or the like. Areas to be analyzed by these analyzing methods are micron to submicron areas, or larger areas, and further the methods are analyzing methods specializing in analysis for surface states.

In the field of semiconductor analysis, it is necessary to locally measure the concentration distribution of impurities or the distribution of electric potential in a microscopic area inside a semiconductor. Accordingly, an analysis per microscopic area is performed with a semiconductor analyzing device wherein an electron microscope is provided with an electron energy spectrometer (see, for example, Japanese Unexamined Patent Publication No. 10-241619 (1998)).

As described above, in conventional analysis of properties about the molecular orbitals of an organic material, areas to be analyzed are, at smallest, micron to submicron areas, and further this analysis specializes in analysis of surface states. Therefore, the amount of obtained information is small, and results of the analysis are applied only to restricted fields.

In the semiconductor analyzing device, wherein an electron microscope is provided with an electron energy spectrometer, an analysis per microscopic area in the order of nanometers can be performed by narrowing the diameter of the electron beam into the order of nanometers. However, it is being considered that when an organic material is measured in the order of micrometers or less, resultant signals become smaller and useful data cannot be obtained. As a result, measurement of areas in the order of nanometers is not made. Sampling technique making it possible to measure organic materials in the order of nanometers is not established. For such reasons, no semiconductor analyzing devices are applied to analysis of organic materials.

Organic devices wherein plural materials including an organic material are laminated have been prepared. It is, however, difficult to take samples per nanometer-order microscopic areas along the direction of the cross section thereof. Therefore, an energy analyzing method using an electron microscope as described above is not established for such devices.

### SUMMARY OF THE INVENTION

In the present invention, organic materials can be analyzed in the order of nanometers by an analyzing method which has not been hit on so far.

An object of the present invention is to provide an analyzing method making it possible to obtain information on states or properties (such as the valence electron transition, electric charge state or potential) of nanometer-order areas in an organic material from the surface direction thereof or the cross-sectional direction thereof by contriving a sampling manner.

In particular, another object of the present invention is to provide an analyzing method making it possible to analyze areas each having a size of 10 nm or less, particularly several nanometers or less, and evaluate the state of the interface generated when different materials, at least one of which is an organic material, are jointed to each other. More specifically, still another object of the present invention is to provide an analyzing method capable of evaluating, for example, the potential gradient of an semiconductor organic material or that of the interface between the electrode of an organic luminous device and the organic layer thereof, (for example, thereby forming a band diagram), so as to realize the expression of a high function of the element.

The method for analyzing an organic material per microscopic area according to the present invention is a method for analyzing an organic material per microscopic area, comprising the step of evaluating, about a specimen containing the organic material, at least one of a potential and an electric charge state of the organic material in an analysis area having a size equivalent to or smaller than a monomolecular size of a molecule of the organic material, or an analysis area to be circumscribed by a circle having a diameter of 0.01 to 10 nm. The wording “an analysis area to be circumscribed by a circle having a diameter of 0.01 to 10 nm” means that the diameter of the circumscribed circle surrounding the analysis area is about 0.01 to 10 nm. The shape of the analysis area per se may be any shape, for example, a circular, elliptic or polygonal shape. The wording “monomolecular size” means a diameter of a circumscribed circle surrounding a single molecule.

The method for analyzing an organic material per microscopic area according to the present invention can be carried out by, for example, a method for analyzing an organic material per microscopic area, comprising the steps of radiating an electron beam into a specimen containing the organic material, the electron beam having a beam diameter equivalent to or smaller than a monomolecular size of a molecule of the organic material to be measured or an electron beam of 0.01 to 10 nm diameter; and analyzing the organic material per microscopic area based on electron energy loss data obtained when the electron beam is transmitted through the specimen. The shape of the electron beam may be any shape, for example, a circular, elliptic or polygonal shape. The wording “beam diameter” means a diameter of a circumscribed circle surrounding an electron beam.

The method for analyzing an organic material per microscopic area according to the present invention using an electron beam can be carried out by a method using an energy filter electron microscope having a monochrometer monochronizing an incidence electron besides the above-mentioned method. The analyzing method of the present invention can be carried out by use of a microscope or the like based on a scanning probe microscope such as a scanning tunneling microscope, conductive atomic force microscope, scanning potential microscope, or scanning spreading resistance microscope, or XPEEM (an X-ray photoelectron microscope) or the like, besides the electron beam.

It is allowable in the present invention to cut out the specimen containing the organic material into a thin piece shape by means of an FIB or a cryomicrotome under a water-free condition; radiate, into the cut-out thin piece specimen, an electron beam having a beam diameter equivalent to or smaller than a monomolecular size of a molecule of the organic material to be measured or an electron beam of 0.01 to 10 nm diameter; and analyze the organic material per microscopic area based on electron energy loss data obtained when the electron beam is transmitted through the specimen.

According to this, under the water-free condition, the organic material is cut out into the thin piece, whereby the organic material does not react with any water so as to make it possible to analyze the chemical state which the organic material itself originally has, such as the electron structure thereof, without giving any change to the state.

It is allowable that the specimen containing the organic material is cut out by means of an FIB, and subsequently a damaged portion generated in a cut-out face of the specimen is cut out by means of a cryomicrotome.

When the specimen is cut out, the thin piece may have a thickness from 1 to 300 nm. According to the present invention, it is possible to measure not only specimens having a thickness of several nanometers but also specimens having a thickness of 10000 nm or more.

It is allowable that the specimen has a structure wherein two or more different materials containing the organic material are laminated, and the specimen is cut out in a direction along which a cross section of a lamination layer of the specimen appears.

The specimen may be an organic EL device.

The specimen may be an organic semiconductor device.

The electron energy loss data may be obtained by means of an energy filter type electron microscopic device.

It is allowable to analyze electron energy loss data generated following transition processes between π-π* electron energy levels, or ionization transition processes, which are related to molecular orbitals of the organic material.

The electron energy loss data may be electron energy loss data generated following transition processes between π-π* electron energy levels, or ionization transition processes, which are related to molecular orbitals of the organic material.

The analysis based on the electron energy loss data may be analysis of a local electric charge state or an electric charge distribution state of the organic material.

The analysis based on the electron energy loss data may be analysis of a local potential or a potential distribution of the organic material.

The analysis based on the electron energy loss data may be analysis of a distribution of a characteristic of an interface between the organic material and another material adjacent thereto and a vicinity of the interface.

The analysis based on the electron energy loss data may be analysis of difference between energy levels related to a transport of electrons or positive holes in a joint area between different materials containing the organic material.

The device for analyzing an organic material per microscopic area according to the present invention may comprise: a specimen-laying section on which a specimen containing the organic material is laid; an electron beam radiating section for radiating an electron beam having a beam diameter of 0.01 to 10 nm into the specimen; and an electron energy loss detecting section for obtaining electron energy loss data when the electron beam is transmitted through the specimen.

The analyzing device may be a device wherein an accelerating energy of the electron beam is adjusted within a range of 5 to 1000 keV so as to control a half band width of an energy loss peak generated by transmission of the electron beam through the specimen into a range of 0.02 to 3.0 eV so as to obtain a transition energy value depending on the specimen.

The analyzing device may further comprise a specimen heating and cooling system.

The analyzing device may further comprise a molecular orbital method calculating function.

According to the present invention, at least one of a potential and an electric state of an organic material can be evaluated in an analysis area having a size equivalent to or smaller than a monomolecular size of a molecule of the organic material, or an analysis area to be circumscribed by a circle having a diameter of 0.01 to 10 nm. Thus, information useful for development of the organic material can be obtained.

When an electron beam is used, novel data, which have not been hitherto obtained in the order of nanometers about an organic material, can be obtained by radiating, into the organic material, an electron beam which has a beam diameter equivalent to or smaller than a monomolecular size thereof, specifically, the electron beam of 0.01 to 10 nm diameter, and then analyzing the organic material per microscopic area based on electron energy loss data generated when the electron beam is transmitted through the specimen.

Information on energies of transition processes between electron energy levels in an organic material can be obtained with a spatial resolution power of 1 nm or less from a surface direction thereof or cross-sectional direction thereof. In particular, the present invention can be applied to evaluation of an interface state generated when different materials are jointed to each other.

A gradient of a potential in an interface between an electrode and an organic layer in a semiconductor organic material or an organic luminous device can be evaluated to prepare a band diagram. Consequently, in this element, expression of a very high function can be realized.

### BRIEF DESCRIPTION OF THE DRAWINGS

FIG. 1 illustrates a method for analyzing electron energy loss with an energy filter type electron microscope, which is an example of the present invention;

FIG. 2 shows analysis results of electron energy loss generated following transition processes between π-π* electron energy levels, or ionization transition processes, which are related to molecular orbitals of a powdery organic material specimen, related to the present invention;

FIG. 3 is a schematic view illustrating a method for giving electric charge to a specimen in order to measure a local electric charge state thereof, related to the present invention;

FIG. 4 is a schematic diagram illustrating a local potential distribution based on an EELS spectrum of a structure containing an organic material, related to the present invention;

FIG. 5 illustrates an example wherein an electron beam is radiated onto a surface of an organic material at a perpendicular angle to evaluate a local electric charge or potential distribution thereof, related to the present invention;

FIG. 6 illustrates an example wherein an electron beam is radiated onto a surface of a structure containing an organic material from a direction perpendicular thereto (cross-sectional direction) to evaluate a characteristic thereof, related to the present invention;

FIG. 7 illustrates an example wherein interface property is evaluated, related to the present invention;

FIG. 8 illustrates an example wherein difference between energy levels related to transport of electrons or positive holes in a joint area between different materials is evaluated with a spatial resolution power of several nanometers or less, related to the present invention;

FIG. 9 shows comparison between measurement results of energy (energy loss) of transmitted electrons and calculation results based on a molecular orbital method, related to the present invention;

FIGS. 10(a) to 10(c) show an effect of an electron beam accelerating energy, related to the present invention; and

FIG. 11 illustrates a heating and cooling system for adjusting specimen temperature, related to the present invention.

### DESCRIPTION OF THE PREFERRED EMBODIMENTS

Referring to the drawings, embodiments of the present invention, using an electron beam, will be described hereinafter.

First, an energy filter type electron microscope (EF-TEM), which makes it possible to select a specific energy from an incidence electron beam and then conduct an analysis, will be described as a device for measuring electron energy loss.

### Energy Filter Type Electron Microscope

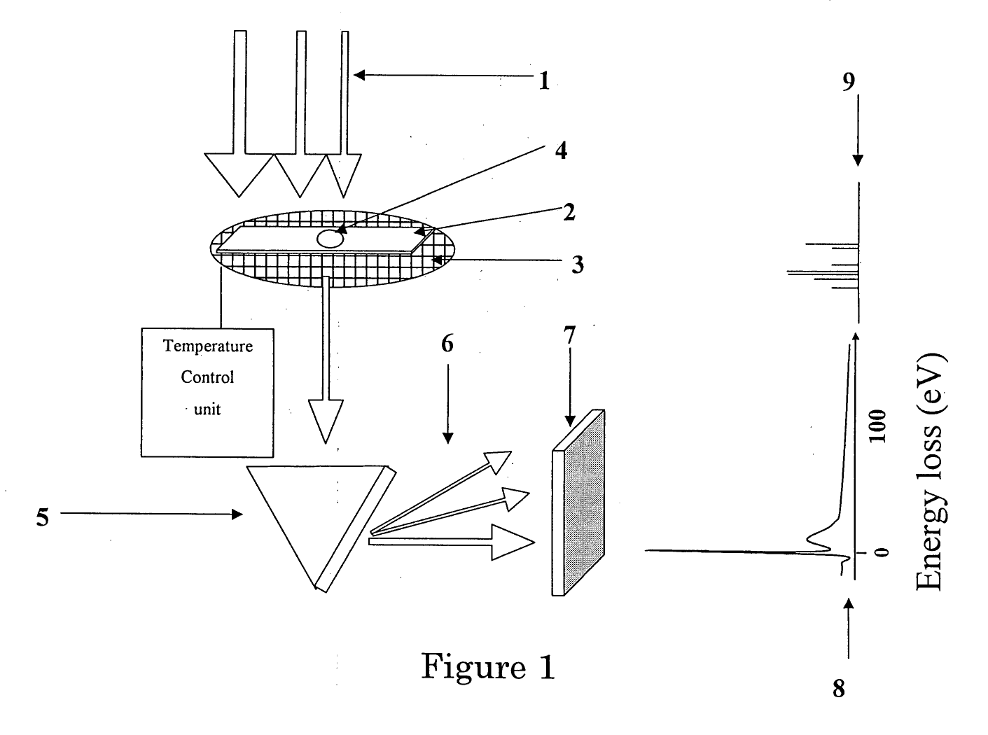

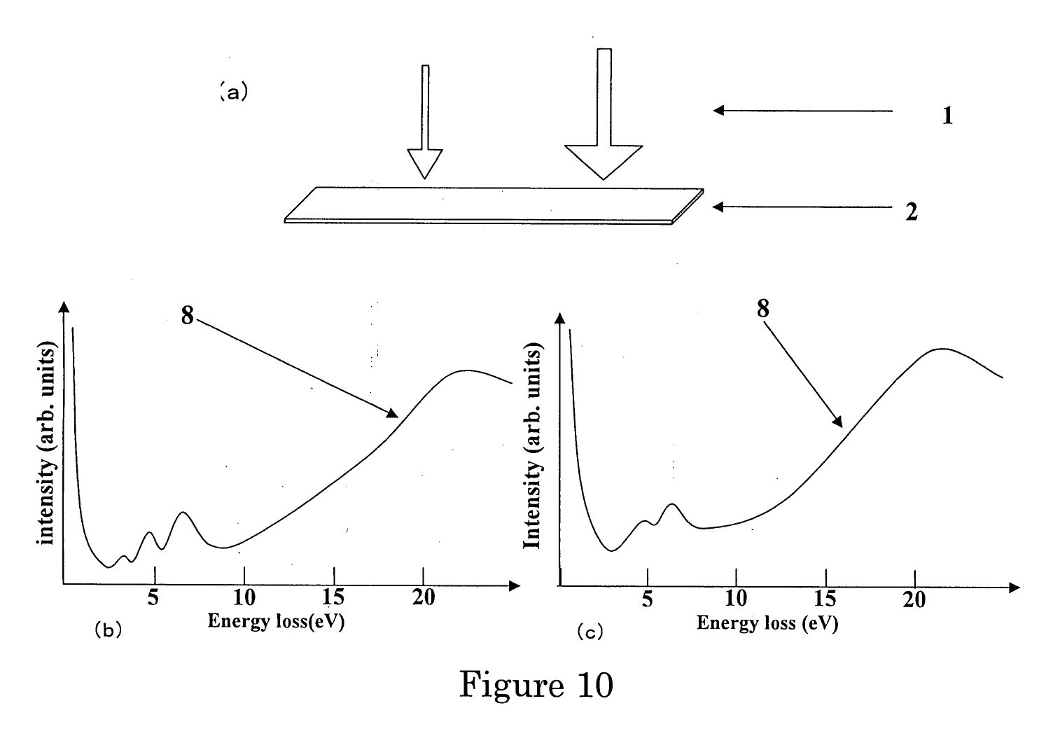

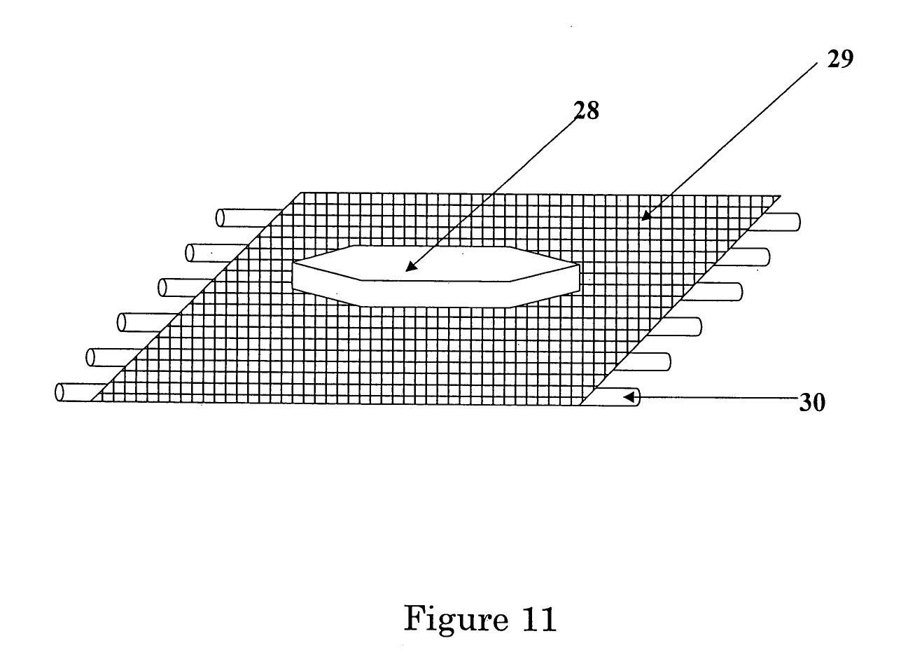

FIG. 1 illustrates a method of measuring electron energy loss by means of an energy filter type electron microscope. In FIG. 1, reference numeral 1 represents incidence electrons, and an accelerating energy for electron beam can be changed in accordance with an object to be analyzed (Effect of the accelerating energy will be described with reference to FIGS. 10(a) to 10(c)). The accelerating energy is adjusted within a range of 5 to 1000 keV through an adjusting system which should be ordinarily fitted to electron microscopes. Reference numeral 2 represents a measurement (observation) specimen made of an organic material. The measurement specimen may comprise a single organic material or plural organic materials, or may be made up to a structure, such as a device containing an organic material. Reference numeral 3 represents a temperature control unit for heating and cooling the specimen which is being analyzed. Thus, under various temperature conditions, measurement can be made (Effect of the heating and cooling will be described with reference to FIG. 11).

Reference numeral 4 represents an analysis area (area irradiated with the electron beam) in the measurement specimen, and the area has a diameter of 0.01 to 10 nm, preferably 0.1 to 5 nm. (In general, this area is an area having a size equivalent to that of a single molecule to be analyzed, or smaller than that of the single molecule.) This area can be obtained by producing an electron beam probe focused by adjusting magnetization of electrostatic lenses (such as a condenser lens and an objective lens) of the electron microscope (the diameter of the probe being generally able to be focused into 0.1 to 5 nm), and then radiating the electron beam from the probe onto the specimen. When the accelerated electron beam is radiated onto the specimen, the area wherein the incidence electrons are diffused within the specimen widens in accordance with kinds of elements which constitute the specimen, the focus angle of the probe, the thickness of the specimen, and others.

Attention is paid in particular to the specimen thickness. When an electron beam probe having an incidence beam diameter of 0 nm is radiated onto a thin film made of pure carbon at an accelerating voltage of 100 keV, the above-mentioned dispersion area widens into 1.9 nm and 0.2 nm in the case of a thickness of 50 nm and a thickness of 10 nm, respectively, from theoretical calculation based on Monte Carlo simulation. In electron beam energy loss (EELS) analysis, only elastically and non-elastically scattered electrons transmitted through a specimen are used as signals. Signals are not obtained from the whole area where the electrons are diffused. In order to attain a spatial resolution power of several nanometers or less, it is necessary to make the beam diameter at the time of analysis as small as possible and further satisfy the condition that the specimen is made as thin as possible, and other conditions.

Specifically, it is desirable that the beam diameter is generally equivalent to the single molecular size of a molecule to be measured, or smaller than the molecular size. Specifically, the beam diameter is desirably from 0.01 to 10 nm (inclusive), and the specimen thickness is desirably 300 nm or less, more desirably 50 nm or less.

Reference numeral 5 represents a spectroscope, such as a magnetic prism, wherein the electron beam is separated for each energy level; 6, the traveling direction of the transmitted electrons, from which specific energies are lost (a non-elastically scattering phenomenon) by various interactive actions onto the specimen, separated by the spectroscope 5 in accordance with every energy; 7, a detector (such as a CCD element) for detecting a lost energy about each of the transmitted electrons separated in accordance with every energy; and 8, an electron beam energy loss (EELS) spectrum gained by means of the detector 7.

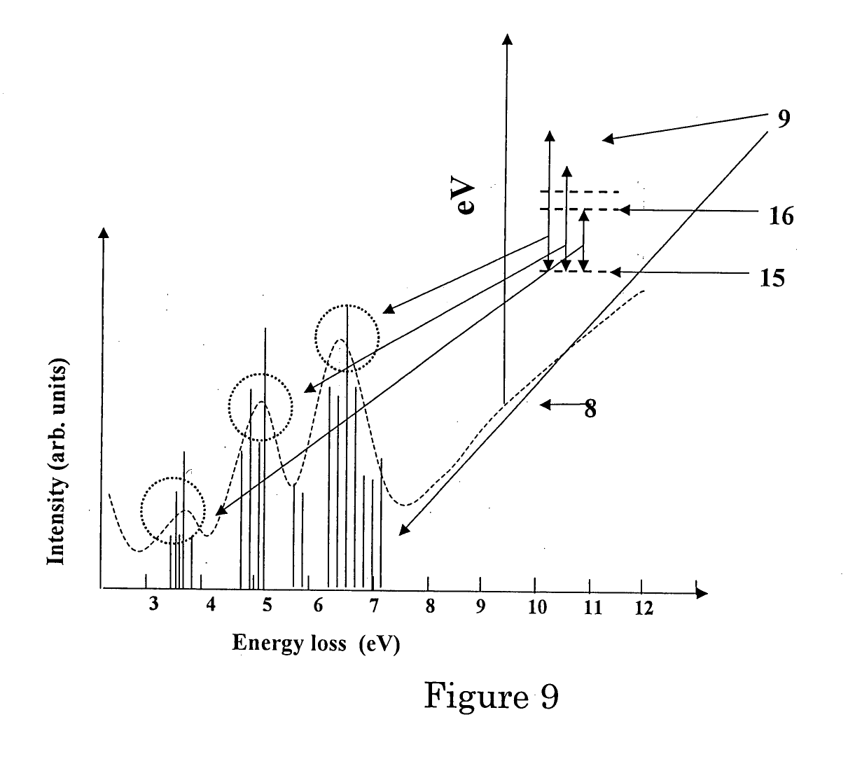

This electron beam energy loss spectrum 8 can be compared with a molecular orbital theory calculation result 9 which is separately obtained from a known calculating manner. (The comparison will be described with reference to FIG. 9.)

### Electron Energy Loss Spectrum

The following describes a method of gaining the electron beam energy loss (EELS) spectrum by means of an energy filter type electron microscope (EF-TEM).

A case wherein the incidence electron beam 1 gives energy to the specimen 2 to excite electrons in the is 1 s orbitals (K shells) of atoms which constitute the specimen is described as an example. In the atoms in the ground state, all of electron energy levels below the Fermi level are occupied by electrons at ambient temperature or temperatures close thereto (although it depends on the temperature of the specimen). Energy levels to which the inner shell electrons in the 1 s orbitals (K shells) are excited are energy levels in an unoccupied state above the Fermi level. Accordingly, when the incidence electrons lose an energy larger than ΔE, which is a difference between the 1 s level and the Fermi level, the probability that the 1 s electrons are excited increases abruptly. Consequently, a sharp peak appears at the energy position of ΔE in the EELS spectrum. The peak making its appearance in the EELS spectrum, resulting from the excitation of the inner shell electrons, is called an edge because the peak has a steep rise shape.

In any organic material, transition processes occur between electron energy levels related to its molecular orbitals, as well as transition processes from the inner shell levels of its constituting atoms. It has been proved that these transition processes related to the molecular orbitals can also be made clear by measuring the organic material with a spatial resolution power of several nanometers or less.

In other words, it has been proved that by limiting the analysis area 4 to 10 nm or less, preferably 5 nm or less, the size of the analysis area 4 becomes substantially equal to that of each of molecules and information peculiar to each of the molecules can be correctly obtained, which is different from information gained from the whole of a molecule group from a macro area and obtained by conventional XPS, UPS, UV-Vis or the like.

Reported in the past was an example of analysis of an organic material with an energy filter type electron microscope (EF-TEM) on polyphenylene ether particles dispersed in polyamide. In this example, each polyphenylene ether particle has a particle diameter of 1 to 5 μmφ. For the polyamide, no energy transition spectrum related to its molecular orbitals is observed, and for the polyphenylene ether, an energy transition spectrum related to its molecular orbitals is only qualitatively observed in a range of 6 to 8 eV

It has been considered so far that in an analysis of an energy loss spectrum, when an analysis area is made as small as a nanometer order size from a micron order size, resultant signals become small and the analysis becomes difficult or disadvantageous. However, in the present invention, it has been proved that even when an analysis area is made into a nanometer order size, contrivance of a manner for preparing a specimen makes it possible to not only make the spatial resolution power into a nanometer order but also measure the electric charge state or local potential induced from transition processes between electron energy levels and information on the transition process.

It has also been proved that comparison of each of energy loss spectra with molecular orbital calculation results makes it possible to give a quantitative meaning to each of the spectra.

Furthermore, it has been proved that in the case that the organic material is in the form of a thin film, evaluation along the direction parallel to the deposition face of the organic material layer (cross-sectional direction) makes it possible to evaluate the depth direction distribution of the electric charge state or the local potential induced from transition processes between energy levels, and information on the transition processes.

### Method for Preparing Measurement Specimens

It is advisable that specimens used in the present invention are prepared under water-free conditions by a cutting method, a typical example of which is cryomicrotome, or a method using ion beams, a typical example of which is a method using a focused ion beam (FIB) device. The reason why the specimens are prepared under water-free conditions is that many of functional organic materials react easily with water and may lose property for electronic materials by the reaction with water.

Portions other than the organic materials may be subjected to a polishing method using both of polishing and ion milling; a method of utilizing an electrochemical reaction using a chemical substance to make the specimens thin, a typical example of the method being electrolytic polishing; a method called lift-off, wherein a specific layer (such as SiO₂) is etched with hydrofluoric acid or the like and then the remaining substance is analyzed; or any other method. These methods may be used in combination.

In any case, it is desirable to use a thin leaf forming method capable of measuring the intrinsic EELS spectrum of the specimen with a spatial resolution power of several nanometers or less without damaging the specimen as much as possible.

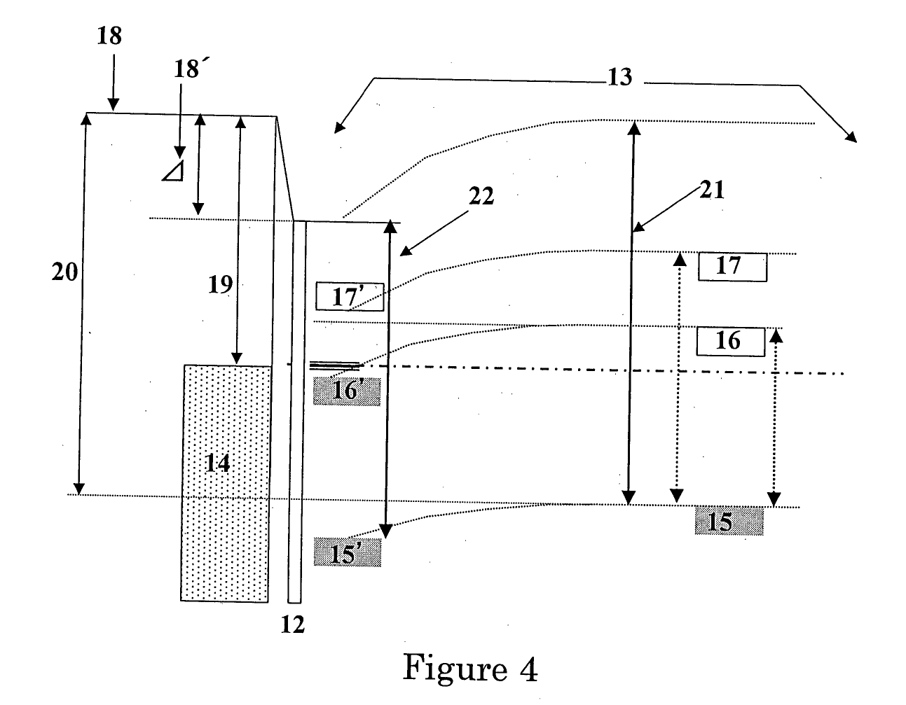

In particular, sampling technique making it possible to analyze the transition processes related to the molecular orbitals, and others with a spatial resolution power of 10 nm or less from the cross-sectional direction of the specimen will be described later with reference to FIG. 4.

It is desirable that the thickness of the specimen is as thin as possible, as long as the specimen can be used for measurement (1 nm or more), and can give effective signals. The thickness is 300 nm or less, preferably 50 nm or less.

About other conditions of the radiated electron beam for gaining the EELS spectrum, it is necessary to suppress damages upon the electron radiation, which occurs when the electron beam is transmitted through the specimen. For example, at room temperature, the electron beam amount (dose) at which the electron beam damages are caused is 3.1 electrons/Å² at an accelerating voltage of 100 keV in the case of polyethylene, and is 100 electrons/Å² at an accelerating voltage of 100 keV in the case of tetracene. The electron beam amount depends on the specimen temperature, measurement time and observation magnification as well as the accelerating voltage.

About the effect of lowering the specimen temperature, the electron beam damage of tRNA substituted with glucose is improved 20.5 times by changing the temperature from room temperature to −265.1° C. Cooling the observation specimen gives an additional effect that the EELS spectrum can be analyzed with a higher precision (the effect being described in detail later with reference to FIG. 11). The electron beam amount giving to the specimen is preferably 0.1 electrons/Å² or less at room temperature, is 10 electrons/Å² or less at −196° C., and is 50 electrons/Å² or less at −250° C.

### EXAMPLES

Examples of the present invention will be described in accordance with conditions of respective specimen of organic materials, or purposes of respective analysis hereinafter.

### Example 1

### Evaluating Method in the Case that Organic Material is Powdery Specimen

First, an evaluating method in the case that the organic material is a powdery specimen will be described.

As a specific specimen, a crystalline powdery specimen of “Alq₃” (compound 1), which is famous as a luminous layer substance of an organic EL material, was used.

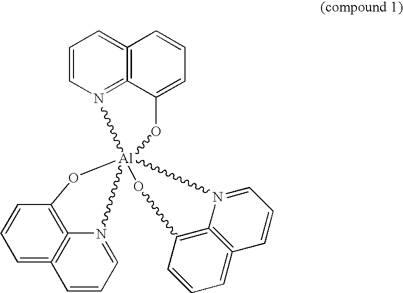

A spatula was used to sprinkle this powdery specimen directly on a grid for electron microscopic observation, and the resultant was used as a specimen for observation. This specimen had a random film thickness distribution, the thickness depending on the size of crystal grains therein. An electron beam focused into a beam diameter of 0.7 nm was radiated, at an accelerating voltage of 80 keV, onto a spot having a film thickness of about 10 nm in the specimen (the spot being decided by electron microscopic observation) so as to obtain information on transition between electron energy levels. Measurement conditions at this time were adjusted in such a manner that the half band width of the so-called “zero loss peak”, giving no energy loss, would cause constant attainment of an energy resolution power of 0.5 eV.

The thus-obtained EELS spectrum was compared with an UV-Vis result 10 based on separate measurement by ultraviolet-visible spectroscopic analysis (UV-Vis). The specimen used in the UV-Vis analysis was a specimen obtained using the Alq₃ powdery specimen as a vapor-deposition source for vapor-deposition onto a quartz substrate at a vacuum degree of 2×10⁻⁴ Pa, a vapor-deposition temperature of 160° C. and a vapor-deposition rate of 0.05 nm/second to have a film thickness of 80 nm while monitoring the film thickness precisely with a film thickness monitor.

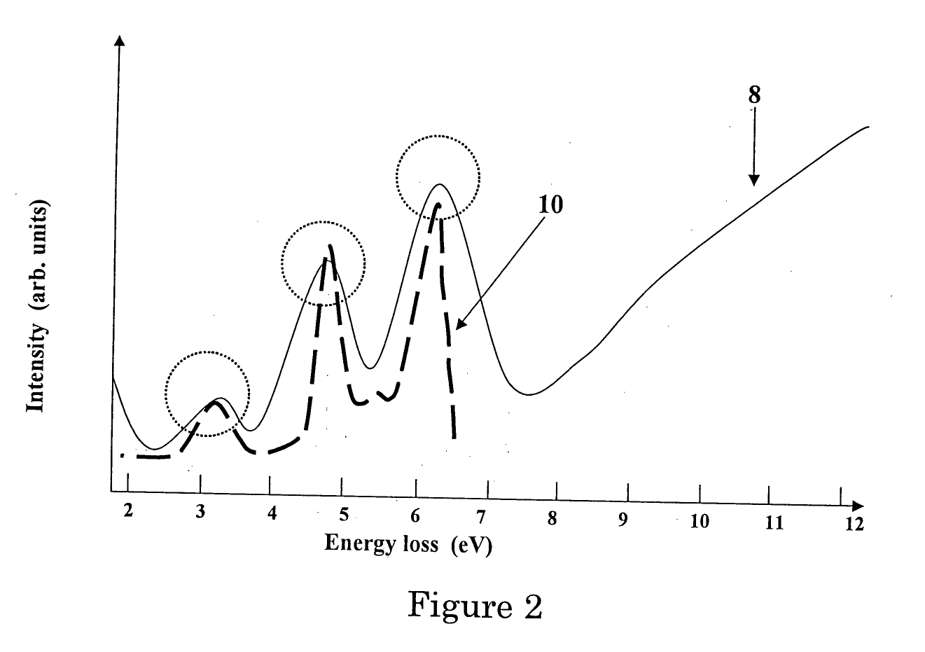

FIG. 2 is a graph showing evaluation of electron spectroscopic property of the powdery organic material specimen observed in analysis areas having a size of 10 nm or less, that is, results of analysis of electron energy losses generated in transition processes between π-π* electron energy levels, ionization transition processes or the like, related to molecular orbitals of the organic material. In FIG. 2, reference numeral 8 represents an EELS spectrum obtained actually from the Alq3 powdery specimen, and reference numeral 10 represents an ultraviolet-visible spectroscopic analysis (UV-Vis) result obtained from the Alq₃ vapor-deposited film specimen as a comparative specimen.

The EELS spectrum 8 and the UV-Vis spectrum 10 were spectra which were sufficiently consistent with each other, which had maximums at 3.3, 4.7 and 6.4 eV.

These peaks are π→π* transition peaks, and the peaks at 3.3, 4.7 and 6.4 eV correspond to a peak corresponding to transition between HOMO-LUMO bands, an energy between band, which is larger than the energy between the HOMO and LUMO(for example, HOMO→LUMO+1), and an ionization energy, respectively (details thereof being described later with reference to FIG. 9).

A functional organic material such as Alq₃ has molecular orbitals peculiar to double bonds or cyclic structures, the orbitals being called π orbitals. The EELS spectrum shown in the example shown in FIG. 2 is generated by plural transitions between electron energy levels from r orbitals which are bonding molecular orbitals occupied by electrons to π* orbitals which are unoccupied antibonding molecular orbitals each having a higher energy.

This area is a part of a 0 to 30 eV loss energy area (Low-loss area) in the EELS spectrum 8 shown in FIG. 1.

These molecular orbitals, typical examples of which are the π, π* , have a relationship corresponding to the HOMO (highest occupied molecular orbital) level, which corresponds to the highest level of the valence band, and the LUMO (lowest unoccupied molecular orbital) level, which corresponds to the lowest level of the conduction band. These levels are used for discussion of electronic behavior of organic materials. For example, the lowest-energy peak shown in FIG. 2 corresponds to the HOMO-LUMO transition.

This observation has been made possible by measuring analysis areas in the order of nanometers.

The HOMO has the highest reactivity among the occupied orbitals, which are occupied by electrons, whereas the LUMO is an orbital having the highest reactivity among the unoccupied orbitals. At the time of constructing an organic device, a typical example of which is an organic electroluminescence (organic EL) device, as one example of the structure containing an organic material, it is required that the efficiency for injecting electrons or positive holes from its electrode to its organic layer is high. For the electron injection, it is required that the organic molecules have a low LUMO value. On the other hand, the positive hole-injecting efficiency has a very high correlation with the HOMO value.

As described above, information on molecular orbitals controlling the electric behavior of an organic material can be obtained at a positional resolution power of 10 nm or less according to the present invention. Therefore, the present invention is very effective for evaluating organic devices.

As compared with other methods such as XPS analysis, the transition peaks from π orbitals to π* orbitals are easily observed with high sensitivity. This is one of advantages of energy filter type transmission electron microscopes (EF-TEM).

### Example 2

### Evaluating Method in the Case of Simple Element Including Organic Material

As an example of evaluation of a functional organic material, a simple element prepared in the following steps was used for the evaluation.

First, an Au electrode was laminated on an acrylic plastic substrate to have a thickness of 50 nm. Alq₃ molecules 13 were vapor-deposited into a thickness of 50 nm, as a luminous layer of an organic EL material, on the Au electrode. Subsequently, LiF 12, which is famous as a cathode buffer layer in organic EL devices, was vapor-deposited thereon at a temperature of 570° C., a vacuum degree of 2×10⁻⁴ Pa and a vapor deposition rate of 0.1 nm/second, so as to yield a cathode buffer layer having a film thickness of 1 nm.

Furthermore, Alq₃ and LiF were alternately vapor-deposited in such a manner that Alq₃ would have a thickness of 10 nm and that of 5 nm and LiF would have a thickness of 0.9 nm and that of 0.7 nm. Finally, Al 14 was vapor-deposited thereon to have a thickness of 50 nm. This element was cut into a thickness of 30 nm with a cryomicrotome, and the resultant was used as a specimen. This specimen was arranged in an EF-TEM device, and an electron beam focused into a beam diameter of 0.2 nm at an accelerating voltage of 80 keV was radiated onto a fixed position or radiated while the position to be analyzed (analysis position) was continuously shifted at intervals of 0.4 nm. In this way, an EELS spectrum was obtained.

In this simple element, analysis was made, in particular, in an area having a distance of 30 nm from the Au electrode inside the area of the 50 nm thickness Alq₃ molecules 13. As a result, transitions from π orbitals to π* orbitals, each of the π* orbitals having a higher energy (π→π* transitions), which show transition processes between electron energy levels, were obtained as a spectrum having maximums at 3.3, 4.7 and 6.4 eV. These values were values consistent with those in a separately-obtained UV-Vis spectrum.

### Example 3

### Evaluation of Local Electric Charge State and Electric Charge Distribution State of Organic Material

The following describes measurement and evaluation of the local electric charge state of an organic material. In the case that, for example, electron or positive holes are injected into a functional organic molecule which is originally a neutral molecule, useful information can be obtained if an electron structure spectrum corresponding to the electric charge state of the molecular structure thereof can be obtained. Correct understanding of the electric charge state of each organic material is a guide to the design of new material and additionally gives very useful information to the production of devices, whereby characteristic, material deterioration and others can easily be forecasted.

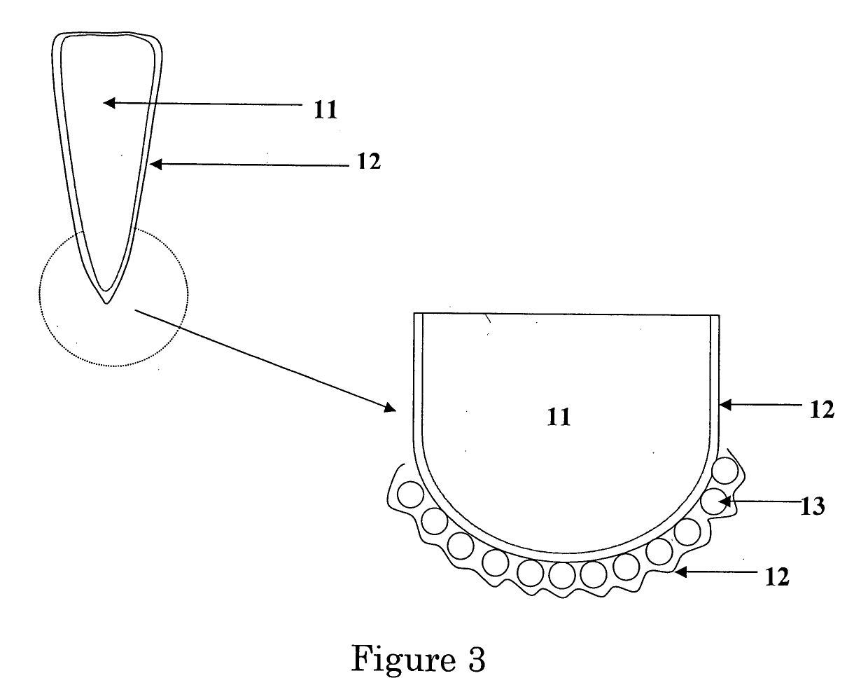

FIG. 3 is a schematic view illustrating a method for giving charges to a specimen in order to measure the local electric charge state or the electric charge distribution state of an organic material. This method uses pseudo-injection of an electric charge, which allows for simple evaluation of a device, such as an organic EL device. This method is used instead of actually preparing a device, and injecting an electric charge into the device.

In FIG. 3, reference numeral 11 represents a Pt probe; 12, lithium fluoride (LiF); and 13, Alq₃ molecules which constitute an organic material to be measured. Lithium fluoride 12 functions as a medium substance having an effect of lowering the barrier of electron injection from the Pt probe 11 to the Alq₃ molecules 13.

Lithium fluoride (LiF) 12, which is used in a cathode buffer layer of organic EL devices, or others, was made into a layer having a film thickness of about 1 nm on the Pt probe 11 for a scanning tunnel microscope, which had a tip diameter of about 10 nmφ by vacuum vapor deposition at an evaporation temperature of 570° C., a vacuum degree of 2×10⁻⁴ Pa and a vapor deposition rate of 0.1 nm/second.

Next, the Alq₃ molecules 13 were vapor-deposited, while the film thickness is monitored precisely with a film thickness monitor, at a substrate temperature of −100° C., a vacuum degree of 2×10⁻⁴ Pa, an evaporation temperature of 160° C. and a vapor deposition rate of 0.05 nm/second, so as to have a film thickness of 10 nm. Thereafter, the substrate was heat-treated for 30 minutes while the temperature thereof was kept at 150° C.

Furthermore, LiF 12 was again made into a layer having a film thickness of about 1 nm thereon by vacuum vapor deposition at an evaporation temperature of 570° C., a vacuum degree of 2×10⁻⁴ Pa and a vapor deposition rate of 0.1 nm/second. By this treatment, a microscopic structure made of a cluster of several Alq₃ molecules and surrounded by the very thin LiF layer was formed in the vicinity of the very thin tip of the Pt probe 11. The Pt probe 11, to which the Alq₃ molecules 13 surrounded by the LiF layer 12 were attached, was introduced into the FE-TEM device so as to be fixed to a position horizontal to a grid for electron microscopic observation.

Subsequently, the Pt probe 11 tip was shifted so that the analysis position was shifted at intervals of 0.4 nm from the Pt probe 11/LiF 12 interface, while an electron beam focused into a beam diameter of 0.2 nm at an accelerating voltage of 80 keV was radiated to the analysis position. Then an EELS spectrum was measured in the same way as in the case illustrated in FIG. 2, while confirming the analysis was for the Alq₃ molecules 13,

As a result, an EELS spectrum having maximums near 3 to 4 eV and 5 eV was obtained from the Alq₃ molecules 13. The peak near 3 to 4 eV corresponded to an energy between bands which was larger than the energy of the HOMO-LUMO band transition (for example, HOMO→LUMO+1), and the peak near 5 eV corresponded to the ionization energy of the Alq₃. The positions of these peaks are clearly different from those of the Alq₃ powdery specimen shown in FIG. 2. This is because according to the method illustrated in FIG. 3 an EELS spectrum corresponding to the Alq₃ molecules in an electric charge state formed by electron donation was obtained since the cluster of the several molecules of Alq₃ was covered with LiF.

The EELS spectrum, for example about the ionization energy of the Alq₃ 13 molecules in the electric charge state generated by the injection of electrons from LiF 12 is compared with that of the neutral state molecules shown in FIG. 2. The comparison provides information useful for organic molecule device design from the viewpoint of element structure, reliability and others. For example, it has been pointed out that deterioration of organic EL elements each having a luminous layer made of Alq₃ molecules has a relation to the electric charge state thereof generated by the injection of electric charge. By evaluating the electric charge state related to the deterioration of these organic elements in the same way as described above, the deterioration mechanism can be made clear.

### Example 4

### Evaluation of Local Potential or Local Potential Distribution State of Organic Material

Local potential or potential distribution can be known by paying attention to electron orbitals such as HOMO and LUMO, and evaluating transition energy with a positional resolution power of several nanometers or less.

A variation in potential distributions depending on combinations of materials of an electrode with organic materials can be understood, for example, by knowing energies of electron transitions (such as HOMO-LUMO transition) on the interfaces formed by the combinations above. Such information gives a finding for controlling the injection efficiency of electrons or positive holes in the interface between materials; therefore, the information can be used to construct a device structure which has not been known so far.

FIG. 4 is a schematic diagram showing a local potential or a potential distribution induced from an EELS about single or plural organic materials, or a structure including these organic materials.

In FIG. 4, reference numeral 14 represents an Al electrode; 15, an occupied state (HOMO) in the position far from an LiF 12/Alq₃13 interface; 16, an unoccupied state (LUMO) in the position far from LiF 12/Alq₃ 13 interface; 17, an unoccupied state in the position far from LiF 12/Alq₃ 13 interface; 15′, an occupied state at (or near) LiF 12/Alq₃ 13 interface; 16′, an occupied state at (or near) LiF 12/Alq₃13 interface; 17′, an unoccupied state at LiF 12/Alq₃ 13 interface; 18, a vacuum level of the Al electrode side; 18′, a vacuum level newly generated resulting from the interface produced by contact of the different materials with each other; 19, the work function of Al; 20, the ionization potential of Alq₃; 21, a transition peak (6.0 eV) preferentially observed at a position 20 nm or more far from LiF/Alq₃ interface; and 22, a transition peak (5.0 eV) observed at a position very near to the LiF/Alq₃ interface.

Specific description is made with reference to FIG. 4. The Al electrode 14 was laminated in a thickness of 150 nm by an electron beam vapor-deposition method on a Si (111) substrate covered with a SiO₂ thermal oxide film having a thickness of 300 nm, by use of a mask composed of lines and spaces each having a width of 100 μm. The Alq₃ molecules 13 were deposited on this substrate at a vacuum degree of 2×10⁻⁴ Pa, a vapor deposition temperature of 160° C. and a vapor deposition rate of 0.05 nm/second to have a film thickness of 50 nm while the film thickness was precisely monitored with a film thickness monitor. Subsequently, LiF 12 was made into a layer thereon at a vapor deposition temperature of 570° C., a vacuum degree of 2×10⁻⁴ Pa and a vapor deposition rate of 0.1 nm/second to have a film thickness of 1 nm.

The mask was again used to prepare the Al electrode 14 in the form of stripes each having a width of 100 μm, as a cathode, on LiF 12 so as to have a film thickness of 150 nm. The thus-prepared specimen was cut into a size 10 μm wide, 5 μm high and 0.5 μm thick by use of an FIB device.

About working conditions in the FIB device, Ga ions were accelerated at 30 keV under a water-free condition to perform sputtering from the surface of the specimen. The amperage at the time of the working was controlled by the size of the narrowed diameter of the ion beam. At the initial stage of the working, the amperage was 20 nA. As the specimen was made thinner, the amperage was made lower step by step as follows: 1000 pA, 500 pA, 100 pA, 50 pA, 30 pA and 10 pA. Finally, the specimen was inclined at ±1 degree and was subjected to surface-cleaning treatment at an accelerating voltage of 5 keV, and amperage of 5 pA.

This thin specimen was embedded in an epoxy resin. Thereafter, in order to make the specimen thinner under a water-free condition, a cryomicrotome was used to adjust the specimen thickness to 30 nm. In this way, a specimen for analysis was prepared.

An electron beam focused into a beam diameter of 0.2 nm at an accelerating voltage of 80 keV was radiated onto this specimen while the position to be analyzed was continuously shifted at intervals of 0.4 nm from the Al electrode 14. In this way, EELS spectra were measured in the same way as shown in FIGS. 2 and 3. FIG. 4 is a potential profile on the electrode interface, prepared based on results of the measurement.

In FIG. 4, reference numerals 15, 16 and 17 represent energies of molecular orbitals in positions far from LiF 12/Alq₃ 13 interface, and correspond mutually to reference numerals 15′, 16′ and 17′, respectively, which represent energies of molecular orbitals in positions near LiF 12/Alq₃ 13 interface. Curve lines are drawn between corresponding energy levels at far and near position, and the curve lines show that the potential profile is curved toward the LiF 12/Alq₃ 13 interface.

Among the reference numerals 15, 16, 17, 15′, 16′ and 17′, the numbers inside white rectangles represent unoccupied states, and the numbers inside gray rectangles represent occupied states. Reference numeral 18 represents a vacuum level viewed from the side of the Al electrode 14 or the side of Alq₃ 13 positioned sufficiently far from the interface, and reference 18′ represents a vacuum level near the interface at the side of Alq₃ 13 (it is known that a potential gradient of about 1.8 eV is generated between the side of the Al electrode 14 and the side of Alq₃ 13, which are newly generated by contact of the Al electrode 14 and LiF 12 with each other).

Reference numeral 19 represents the value of the work function of the Al electrode 14, the value being about 4.3 eV. With reference to FIG. 4, the energy level of Alq₃ 13 positioned sufficiently far from the interface will be first described.

Reference numeral 20 represents the ionization potential of Alq₃ 13, and the value is reported to be a value of 5.7 to 6.6 eV. Reference numeral 15 represents the energy level of the HOMO which Alq₃ 13 has; 16, the energy level of the LUMO which Alq₃ 13 has; 15′, the energy level of the HOMO at a position very near to the interface newly generated by the contact of LiF 12 and the Alq₃ with each other.

Reference numeral 21 represents a transition peak preferentially observed at a position 20 nm or more far from the LiF 12/Alq₃ 13 interface, and in general the value thereof is about 6.0 eV. As described with reference to FIG. 2, this value corresponds to the ionization energy of the Alq₃ molecules 13 in neutral state.

Reference numeral 22 represents a transition peak preferentially observed at a position very near to the LiF 12/Alq₃ 13 interface, and the value thereof is about 5.0 eV. As described with reference to FIG. 2, this value also corresponds to the ionization energy of Alq₃ 13 molecules in an electric charge state. At the very near to the LiF 12/Alq₃ 13 interface, the vacuum level drops by about 1.8 eV. The HOMO also drops by about 0.5 eV. It can be therefore considered that about 5.0 eV was observed as the ionization energy, which is an energy difference from the HOMO to the vacuum level.

The difference of peak positions observed in the two areas is a phenomenon observed in structure wherein different materials, such as LiF 12 and Alq₃ 13, are combined so as to be close to each other, and is generated by the curve of the potential profile in the vicinity of the interface therebetween.

At positions far from the interface, the energy loss peak of isolated Alq₃ 13 is preferentially observed corresponding to the transition 21 because Alq₃ 13 does not receive any electric effect from the LiF 12 layer. On the other hand, in the vicinity of the LiF 12 layer, a potential distribution is generated by the supply of electrons from the LiF 12 layer. As a result, the new occupied state 16′ corresponding to the level 16, which is originally the LUMO level, is generated. This level is a newly-generated level resulting from partial occupation of the neutral-state LUMO level by a small electric charge, smaller than that of one electron. This level is distinguished from the HOMO level, wherein two electrons having spins contrary to each other are filled, observed in, for example, the neutral-state Alq₃ 13 molecules. Similarly, the new occupied state 15′ is also generated corresponding to the level 15, which is originally the HOMO level.

Consequently, in the case that an electron beam is transmitted, the energy loss based on the transition process 22, which is different from the energy loss based on the transition 21, is generated. By observing the energy loss, the local potential or potential distribution in the vicinity of the interface can be detected with a spatial resolution power of several nanometers or less.

### Example 5

### Confirmation of Nanometer Order Measurement Using Verifying Specimen

The following describes an example wherein a standard specimen for confirming nanometer order measurement is prepared in order to check an actual measurement resolution power of an organic material.

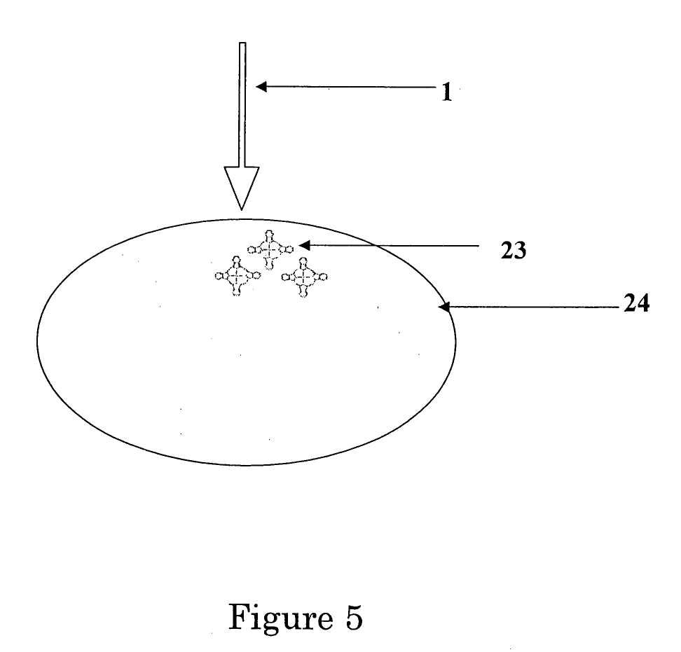

FIG. 5 illustrates an example wherein an electron beam is radiated onto the surface of an organic material at 90 degree or at a finite angle including 90 degree to evaluate transition processes between electron energy levels in the organic material, the local electric charge state of the organic material, or the local potential distribution of the organic material with a spatial resolution power of several nanometers or less.

Reference numerals 1, 23 and 24 represent an accelerated incidence electron beam, copper phthalocyanine and polyvinyl alcohol (PVA), respectively.

In 500 mL of a solution of concentrated sulfuric acid, 0.01 g of copper phthalocyanine 23 (compound 2) was dissolved as a molecule for dispersion.

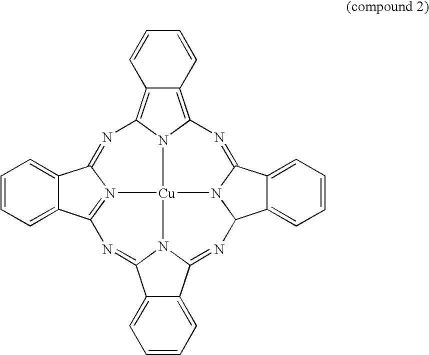

Separately, a flask wherein polyvinyl alcohol (PVA) 24 (compound 3) was put into 1000 mL of water was cooled with ice water.

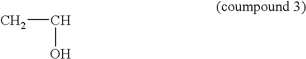

Thereto was added 1 mL of the concentrated sulfuric acid solution mixed with copper phthalocyanine 23. By this treatment, fine crystalline particles made of 1 to 10 molecules of copper phthalocyanine 23 were generated in PVA 24. The resultant was used as a model specimen of a dispersed system of functional molecules (standard specimen for evaluating measurement resolution power).

This sample was made into a thin piece having a thickness of 30 nm with a cryomicrotome. The thin piece was put on a grid for electron microscopic observation and then observed, using an electron beam focused into a beam diameter of 0.2 nm at an accelerating voltage of 120 keV. In this way, EELS spectra were gained.

A π→π* transition spectrum was gained near 5.8 eV only from areas containing copper phthalocyanine 23. Only the loss energy of 5.8 eV was spectroscopically treated to form an image. As a result, the image was an image wherein the fine crystal containing copper phthalocyanine 23 gives bright contrast and the area containing only PVA had dark contrast.

The area containing copper phthalocyanine 23 had a dispersion of 1.5 to 15 nm, and the compound 23 was substantially uniformly dispersed in PVA 24. This result demonstrates that evaluation of characteristic of the organic material can be observed with a spatial resolution power of 2 nm or less.

Evaluation of respective states of materials dispersed at a nanometer level, such as the above-mentioned dispersed system model specimen, makes it possible to evaluate the affinity between the materials, or others.

For an attempt to improve the electric conductivity of a plastic film by dispersing two or more materials into the plastic, useful information can be obtained by visualizing the dispersion state of functional organic molecules having an effect for improving an electric conductivity.

### Example 6

### Evaluation of Cross Section of Multilayered Structure of Organic Material

The following describes an example wherein an electron beam is radiated onto a structure made of a multilayered film comprising an organic material from the direction of a cross section thereof.

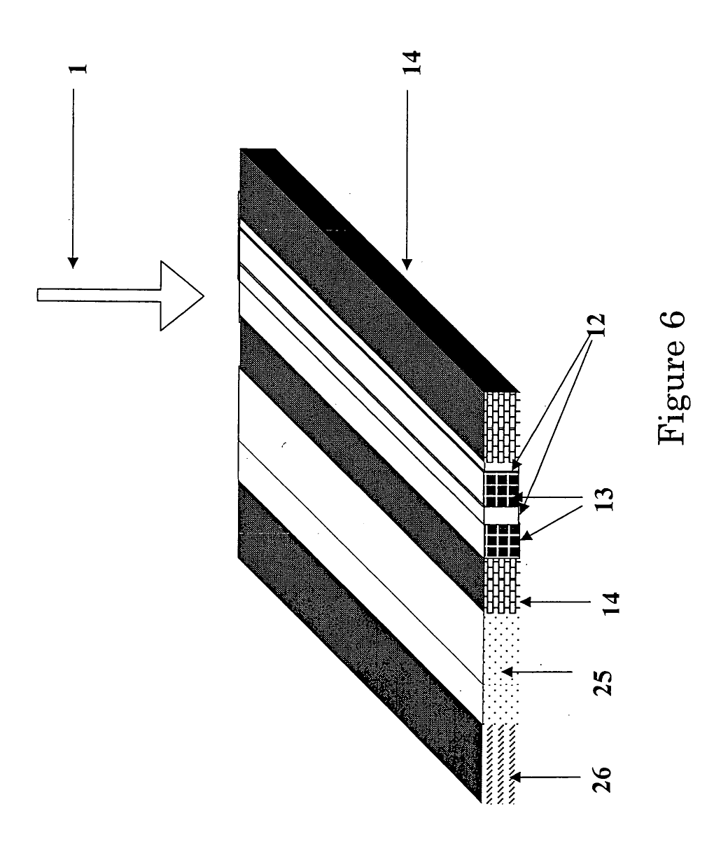

FIG. 6 is a schematic view illustrating an example wherein an electron beam was radiated onto a surface of a structure comprising an organic material from the direction perpendicular to the surface (cross-sectional direction) so as to evaluate, with a spatial resolution power of several nanometers or less, characteristics thereof, for example, transition processes between electron energy levels, the local electric charge state of the organic material, and the local potential distribution of the organic material.

In FIG. 6, reference numeral 1 represents an incidence electron beam; 12, LiF molecules; 13, Alq₃ molecules; 14, an Al electrode; 25, a SiO₂ thermal oxide film having a thickness of 300 nm; and 26, a Si (111) substrate.

By developing the example described with reference to FIG. 4 further, the following can be understood. In the same way as illustrated in FIG. 4, by electron beam vapor deposition, the Al electrode 14 was formed on the Si (111) substrate 26 covered with the SiO₂ thermal oxide film 25 having a thickness of 300 nm. This Al electrode 14 was laminated to have a thickness of 150 nm, using a mask composed of lines and space each having a width of 100 μm.

Alq₃ 13 was deposited on this substrate at a vacuum degree of 2×10⁻⁴ Pa, a vapor deposition temperature of 160° C. and a vapor deposition rate of 0.05 nm/second to have a film thickness of 50 nm while the film thickness was precisely monitored with a film thickness monitor. Subsequently, LiF 12 was made into a layer thereon at a vapor deposition temperature of 570° C., a vacuum degree of 2×10⁻⁴ Pa and a vapor deposition rate of 0.1 nm/second to have a film thickness of 1 nm.

Alq₃ 13 was again deposited on this substrate at a vacuum degree of 2×10⁻⁴ Pa, a vapor deposition temperature of 160° C. and a vapor deposition rate of 0.05 nm/second to have a film thickness of 50 nm while the film thickness was precisely monitored with the film thickness monitor. Subsequently, LiF 12′ was made into a layer thereon at a vapor deposition temperature of 570° C., a vacuum degree of 2×10⁻⁴ Pa and a vapor deposition rate of 0.1 nm/second to have a film thickness of 3 nm.

The mask was again used to form the Al electrode 14 in the form of stripes each having a width of 100 μm, as a cathode, on LiF 12 so as to have a film thickness of 150 nm. The thus-formed specimen was cut into a size 10 μm wide, 5 μm high and 0.5 μm thick under a water-free condition by use of an FIB device.

About working conditions in the FIB device, Ga ions were accelerated at 30 keV to perform sputtering from the surface of the specimen to the depth thereof in sequence. The amperage at the time of the working was controlled by the size of the narrowed diameter of the ion beam. At the initial stage of the working, the amperage was 20 nA. As the specimen was made thinner, the amperage was made lower step by step as follows: 1000 pA, 500 pA, 100 pA, 50 pA, 30 pA and 10 pA.

Finally, the specimen was inclined at ±1 degree and was subjected to surface-cleaning treatment at a voltage of 5 keV, and amperage of 5 pA. This thin specimen was embedded in an epoxy resin. Thereafter, in order to make the specimen thinner, a cryomicrotome was used to cut the specimen so as to make it possible to observe the cross section of the specimen having a thickness of 30 nm. In this way, a specimen for analysis was prepared.

An electron beam focused into a beam diameter of 0.2 nm at an accelerating voltage of 80 keV was radiated onto this specimen while the position to be analyzed was continuously shifted at intervals of 0.4 nm from the upper side Al electrode 14. The potential profile of Alq₃ 13 was observed. As a result, a transition peak was observed mainly near 6.0 eV with a good reproducibility. The spatial resolution power when these characteristics were evaluated was 1.5 nm or less.

### Example 7

### Evaluation of Interfaces in Multilayered Film Structure of Organic Material

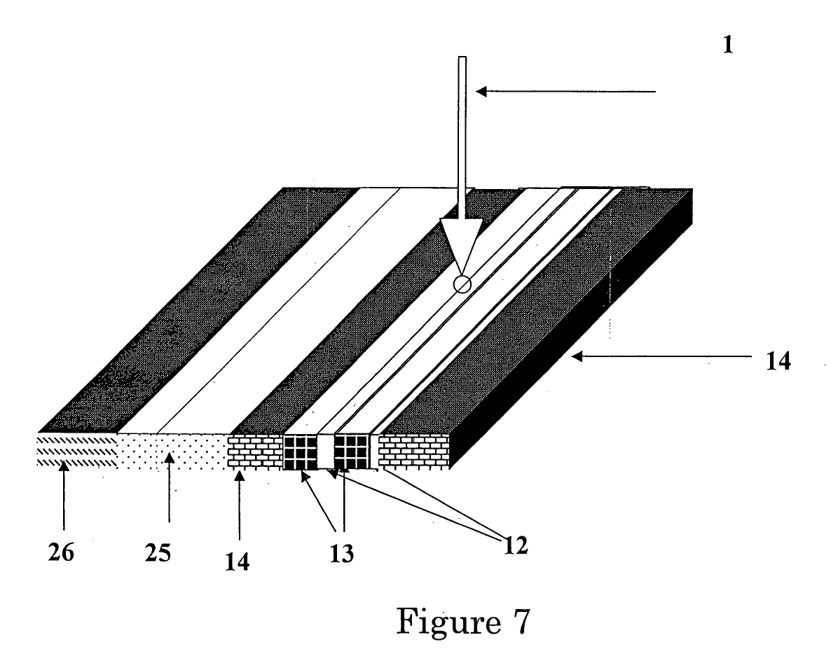

FIG. 7 illustrates an example wherein interfaces between different materials and the vicinity thereof in a structure comprising an organic material were subjected to characteristic distribution evaluation with a spatial resolution power of several nanometers or less. In this example, in the specimen constitution of FIG. 6, accelerated incidence electrons are radiated into the interface areas.

That is, an FIB device was used to cut out the structure into a size 10 μm wide, 5 μm high and 0.5 μm thick. The cut-out thin specimen was embedded in an epoxy resin. In order to make the specimen thinner, a cryomicrotome was used to cut the specimen so as to make it possible to observe the cross section of the specimen having a thickness of 30 nm. In this way, a specimen for analysis was prepared.

An electron beam focused into a beam diameter of 0.2 nm at an accelerating voltage of 80 keV was radiated onto this specimen while the position to be analyzed was continuously shifted at intervals of 0.4 nm from the upper Al electrode 14. The potential profile of the vicinity of the interface between LiF 12/Alq₃ 13 was observed.

As a result, from both of LiF of 1 nm thickness and LiF of 3 nm thickness, the situation that the potential profile was curved was observed only near the respective Alq₃ 13 interfaces. The spatial resolution power at this time was 1.5 nm or less.

The structure comprising the organic material may be not any laminated-film structure but may be a structure wherein two or more materials are dispersed. In both the cases, it has been proved that in interfaces or the vicinity thereof, characteristics based on the electron structure thereof are different from characteristics thereof in the state that they are isolated.

Guidelines for material design and device design have been obtained by analyzing characteristics, such as transition processes between electron energy levels in the interface between an organic material and an inorganic material, or in the interface between an organic material and another organic material, which constitute, for example, an organic EL device.

### Example 8

### Difference Between Energy Levels Related to the Transport of Electrons or Positive Holes in Joint Area

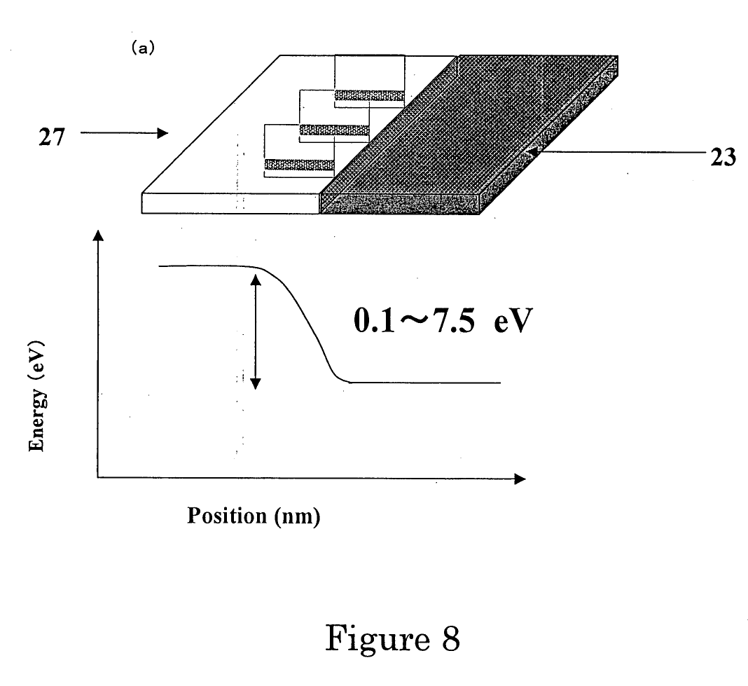

FIG. 8 illustrates an example wherein a difference between energy levels related to the transport of electrons or positive holes in a joint area between different materials in a structure comprising plural organic materials was evaluated with a spatial resolution power of several nanometers or less, and a device was formed based on the resultant value. Reference numerals 23 and 27 represent copper phthalocyanine and polyvinyl carbazole which contains carbon nano-tubes, respectively.

For example, different organic materials are jointed to each other to form an interface so that the shift amount of its HOMO energy position is in a range of 0.5 to 3.0 eV. This makes it possible to realize organic devices having a joint interface capable of efficiently realizing smooth movement of positive holes, preventing excessive positive holes from diffusing to the side of a cathode, and generating excitons efficiently for applied electric power.

About these electronic devices, comparison or evaluation about electron energy levels related to the transport of electrons or positive holes in the interface between different materials can be performed, using ionization potential, an energy between bands which is larger than the energy of HOMO-LUMO band transition (for example, HOMO→LUMO+1) and the HOMO-LUMO band transition in the case of organic materials, or using ionization potential, a known work function or the like in the case of metal materials.

Specific examples thereof will be described hereinafter. The following compounds as polymer organic EL luminous materials were jointed in various ways, and then their capability as an electronic device were evaluated:

polyvinyl carbazole (PVK) (compound 4):

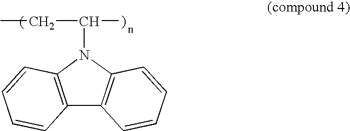

Alq₃ 13, quinacridone derivative (compound 5):

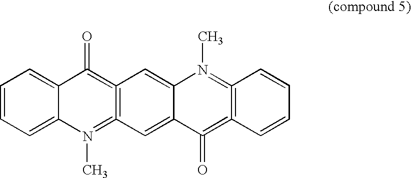

mixed Alq₃ film, copper phthalocyanine 23, 4,4′-bis[N-(1-naphthyl)-N-phenylamino]biphenyl (compound 6):

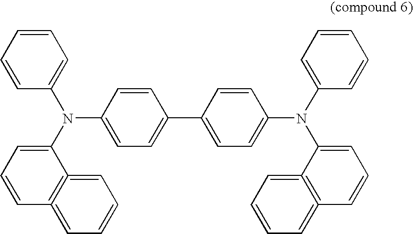

polydeoxythiophene (PEDOT, compound 7):

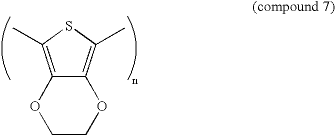

polythiophene (compound 8):

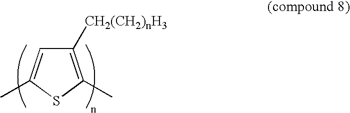

and other compounds.

As a result, the comparison of the HOMO energy positions (each induced from the ionization energies) of adjacent organic materials has made it clear that the transition energy difference in organic compound/organic compound joint interfaces is preferably within a range of 0.5 to 3.0 eV.

As an electrode material other than Al, the following material may be used: a noble metal such as Au or Ag, an oxide such as ITO, a halogen material such as LiF, a magnetic material such as Fe, a material wherein a high-concentration impurity is injected into a semiconductor material such as Si, a carbon type material, an alkali material such as Na, or some other material. Then, it has been made clear that the transition energy difference in organic material/inorganic material interfaces is preferably within a range of 0.5 to 3.0 eV.

For example, FIG. 8 shows a product wherein PVK 27 containing carbon nano-tube was jointed to copper phthalocyanine 23. First, PVK was dissolved into toluene to have a concentration of 5% by weight and subsequently thereto was added 0.3 g of carbon nano-tubes. An ultrasonic cleaner was then used to disperse the carbon nano-tubes in the solution.

This specimen was used to form a thin film 27 of 70 nm thickness with a spin coater at a rotation speed of 10000 rpm. Copper phthalocyanine 23 was vapor-deposited on this thin film at a vacuum degree of 2×10⁻⁴ Pa and a vapor deposition rate of 0.2 nm/second while the film thickness was precisely monitored with a film thickness monitor. In this way, a layer of 70 nm thickness was obtained.

Thereafter, a Ca/Ag electrode was formed on the side of PVK, and an ITO electrode was prepared on the side of copper phthalocyanine 23. When an electric field of 5 V was applied to the resultant, it emitted light at a luminance of 100 cd/m².

Separately, a film of PVK to which no carbon nano-tubes were added and a film of copper phthalocyanine 23 were jointed to each other. A Ca/Ag electrode was then formed on the side of PVK, and an ITO electrode was prepared on the side of copper phthalocyanine 23. When an electric field of 0 to 10 V was continuously applied to the resultant, it emitted no light.

In the same way as shown in FIG. 6, an FIB device was used to cut out each of the two specimens into a size of 10 μm wide, 5 μm high and 0.5 μm thick. About working conditions in the FIB device, Ga ions were accelerated at 30 keV to perform sputtering from the surface of the specimen. The amperage at the time of the working was controlled by the size of the narrowed diameter of the ion beam. At the initial stage of the working, the amperage was 20 nA. As the specimen was made thinner, the amperage was made lower step by step as follows: 1000 pA, 500 pA, 100 pA, 50 pA, 30 pA and 10 pA.

Finally, the specimen was inclined at ±1 degree and the specimen was subjected to surface-cleaning treatment at an accelerating voltage of 5 keV and amperage of 5 pA. This thin specimen was embedded in an epoxy resin. Thereafter, in order to make the specimen thinner, a cryomicrotome was used to cut the specimen so as to make it possible to observe the cross section of the specimen having a thickness of 30 nm. In this way, a specimen for analysis was prepared. An electron beam focused into a beam diameter of 0.2 nm at an accelerating voltage of 80 keV was radiated onto this specimen while the position to be analyzed was continuously shifted at intervals of 0.4 nm from the upper Al electrode 14. In this way, EELS spectra were gained. As a result thereof, the difference in the π→π* transition energy in this interface was 0.7 eV.

Similarly, the difference in the π→π* transition energy in the interface in the non-luminous element was evaluated. The difference was 0.1 eV.

When the peak identified in each of the measurements is considered as the ionization energy of each of the materials, it appears that when the energy gap in the interface was too small, carriers flowed to the counter electrode for the carries (ie., the negative electrode in the case of positive holes) so that the device in this case did not function as a luminous device.

As described above, characteristics of the structure comprising the organic materials were able to be evaluated with a spatial resolution power of 2 nm or less.

### Example 9

### Comparison of Electron Energy Loss Data with Molecular Orbital Method Calculation Results

FIG. 9 shows data based on an organic material microscopic area analyzer capable of radiating an electron beam onto an organic material, measuring/analyzing the energy of the transmitted electrons (energy loss), making calculation based on the molecular orbital method, and comparing the measured values and the calculated values about a characteristic of the material with each other.

Reference numeral 8 represents the EELS data spectrum in FIG. 2; 9, molecular orbital method calculation results; 15, HOMO level; and 16, LUMO level.

This analyzer makes the following possible: the energy values of transition processes between electron energy levels in an organic material which constitutes a specimen are assigned to the quantum-mechanically calculated values about molecular orbitals of the organic material, and further the electric charge state, the potential distribution and others which are generated in connection with the structure of the specimen are considered, whereby the electron structure of the material or the structure can be totally evaluated.

The molecular orbital calculation can be carried out using a density functional method or the like. A function for the calculation may be integrated into a calculator inside an EF-TEM control device, or the calculation may be separately carried out by a calculator system.

By evaluating, based on energy values obtained from this calculation, the electric charge state, potential or the like of a specimen in accordance with the structure of the specimen, it has been made able to show the energy diagram, without any inconsistency, of a device structure when any one of various materials is used and attain designs of highly efficient materials or devices design which has not been realized so far in device development.

By use of a density functional method molecular orbital calculating program, a molecular structure corresponding to the minimum energy of the Alq₃ molecules 13 was obtained in order to cause the structure to correspond to the EELS spectrum of the neutral-state (powdery) specimen of the Alq₃ molecules 13 shown in FIG. 2.

Next, about the Alq₃ molecules 13 the molecular structure of which was optimized in this way, the optical absorption spectrum thereof was calculated. At this time, molecular orbitals before and after each transition were simultaneously calculated, and they were visualized. Since the density functional calculation has a tendency that any HOMO-LUMO band gap energy is underestimated, the energy is corrected by a correction coefficient. a correction factor was beforehand caused to be involved in the calculation.

After the end of the calculation, the resultant spectrum and the three-dimensional shape of the electron cloud that each of the molecular orbitals showed were examined in detail. It was then determined whether or not each transition related to the spectrum was a transition between π→π* electron energy levels.

The results were plotted in a graph 9 wherein the horizontal axis refers to the transition energy between the various molecular orbitals, and the vertical axis refers to the transition oscillator intensity. The results were compared with the EELS spectrum 8 and the UV-Vis spectrum 10.

When the three transition peaks obtained in FIG. 2 were compared with the calculation results, it was confirmed that the calculation results, which have maximums at 3.3, 4.7 and 6.4 eV, are very consistent with the actually measured values.

Furthermore, a similar calculation was carried out about negatively-charged Alq₃ molecules, and it was confirmed that the calculation result had a consistency with the data related to the molecules in the electric charge state shown in FIG. 3 About the specimen having the potential distribution shown in FIG. 4, the EELS spectrum in the position far from the LiF 12/Alq₃ 13 interface shows values close to transition energies from calculation about neutral Alq₃ molecules whereas a shift to the side of lower energies is shown in the vicinity of the interface. This is because an original unoccupied level (LUMO) is partially filled so as to turn to a newly occupied level (HOMO) by the effect of the curve of the potential profile. This result is consistent with FIGS. 3 and 4. By comparing observed data with molecular orbital calculation data in this way, it is possible to decide effectively the electron structure of an organic material or a structure comprising an organic material.

### Example 10

### Effect of Electron Beam Accelerating Energy on an EELS Spectrum

FIG. 10(a) is a schematic view illustrating a situation that transition energies between electron energy levels of a material are precisely obtained by controlling an accelerating energy of an electron beam used in analysis in accordance with the composition of the material, the structure thereof, and others.

Reference numeral 1 represents an accelerated incidence electron beam; 2, an observation specimen, which is a crystalline powdery specimen of Alq₃ molecules 13 having a constant thickness of about 10 nm; and 8, an actually-obtained EELS spectrum.

The accelerating energy is set within a range of 5 to 1000 keV, and in accordance with the set value, the used electron optical system is automatically adjusted so as to turn the half band width of the zero loss peak or the loss peak resulting from an inner shell excitation peculiar to each of various materials, for example, the 1S peak of carbon to a half band width set in advance within a range of 0.02 to 3.0 eV. In this way, the detection of signal peaks of the object to be measured is prevented from being hindered by a widened skirt of the zero loss peak, or some other cause. Moreover, damage of the specimen based on the electron beam is reduced. Thus, transition energies between electron energy levels in the material or the structure of the specimen can be evaluated with a spatial resolution power of several nanometers or less.

FIGS. 10(b) and 10(c) show EELS spectra obtained from the crystalline powdery specimen made of the Alq₃ molecules 13 having the constant thickness of about 10 nm, wherein FIGS. 10(b) and 10(c) correspond to accelerating voltages of 80 keV and 200 keV, respectively, of the incidence electrons

The used spectroscope was adjusted to turn the half band widths of the zero loss peaks into values of 0.5 eV and 0.7 eV, respectively. The energy resolution power, which is represented by the half band width of the zero loss peak, is improved by lowering the accelerating voltage. Separately, the energy widths of the peak skirts at positions having intensities of 1/100 of the maximum intensities (I₀) of the zero loss peaks were measured. The energy widths were 2.7 and 4.8 eV, respectively. Thus, it was made clear that these also depend largely on the accelerating voltage.

The EELS spectra obtained at the respective accelerating voltages are compared with each other. As already described with reference to FIG. 2, in the case that an electron beam focused into a beam diameter of 0.7 nm at an accelerating voltage of 80 keV was radiated to obtain an EELS spectrum, the obtained EELS spectrum had three clear peaks having maximums at 3.3, 4.7 and 6.4 eV.

On the other hand, in the case that an electron beam focused into a beam diameter of 0.7 nm at an accelerating voltage of 200 keV was radiated to obtain an EELS, no peak at 3.3 eV close to the zero loss peak was observed but only the two peaks having maximums at 4.7 and 6.4 eV were observed.

In analysis of a transition spectrum, data at approximately several electron volts near the zero loss peak are used. Therefore, as the energy width of the skirt of the zero loss peak becomes smaller, the precision of the transition spectrum analysis becomes higher. However, a higher accelerating voltage leads to a higher image resolution power of the electron microscope. Therefore, it is necessary to select an accelerating voltage in accordance with particular cases, for example, a case wherein an organic material forms an interface with a metal electrode, and a case wherein an organic material contains a large amount of a heavy element, wherein the element has a large atomic number and have a high resistance against electron beams.

### Example 11

### Effect of Heat

FIG. 11 illustrates a heating and cooling system for adjusting the temperature of a specimen when transition energies thereof are analyzed.

In FIG. 11, reference numeral 28 represents a monocrystal thin film made of the above-mentioned Alq₃ molecules 13; 29, a lattice form sheet made of graphite; and 30, pipes made of tungsten, through which cooling liquid helium can be passed. The pipes 30 per se can be heated.

The lattice form sheet 29 is used to conduct heat from the heating and cooling pipes effectively to the specimen, and the specimen is analyzed using an electron beam passed through the specimen and transmitted from between the lattices. Intervals between the pipes are adjusted to produce no effect on the analysis using the transmitted electron beam. In such a method, an EELS spectrum can be gained while the heating and cooling of the specimen are adjusted.

It is known that organic material is turned into various forms by a process for heating or cooling the material. Dependently on particular devices using an organic material, stability in high temperature environment may be required. Thus, it may be necessary to make an evaluation at a temperature different from ambient temperature.

As an additional effect produced by cooling the specimen, an effect of avoiding the electron beam damage of the organic material can be expected.

This method can also be applied to materials other than organic materials. About carbon type materials, characteristics of each of the materials (such as transition energy), on which thermal physical properties of the material are reflected, can be precisely and continuously obtained by adjusting the temperature of the material within a range of −270 to 600° C. About materials other than carbon type materials, the same matter can be attained by adjusting the temperature within a range of −270 to 1500° C.

Effect of heat is specifically described, using the Alq₃ molecules 13 as an example. The Alq₃ molecules 13 have a melting point of 412° C., a grass transition temperature of 175° C. and crystallization temperatures of 328° C. and 200° C.

The used specimen was a product obtained by depositing a vapor deposition film made of the Alq₃ molecules 13 on a grid for electron microscopic sample observation at a vacuum degree of 2×10⁻⁴ Pa, a vapor deposition temperature of 160° C. and a vapor deposition rate of 0.05 nm/second so as to have a thickness of 50 nm while monitoring the film precisely with a film thickness monitor set inside a vacuum device.

This specimen was subjected to heat treatment from room temperature to a higher temperature. As a result, an area where the film in an amorphous form was crystallized was observed near 175° C. An electron beam focused into a beam diameter of 0.2 nm at an accelerating voltage of 80 keV was radiated onto this sample while the position to be analyzed was continuously shifted at intervals of 1 nm. In this way, a transition spectrum based on EELS analysis was observed. As a result, intense peaks were observed at energy positions of 4.7 and 3.3 eV, as well as at an energy position of 6.0 eV, where a main peak was observed. Thus, only the loss energy at 4.7 eV was selected to form an image. As a result, it was observed that only the crystallization area had a bright contrast, and growth points of crystal grains therein, that is, nucleus generated points were able to be found.

On the basis of the above-mentioned observation, nucleus generated points are created with a high controllability, thereby making it possible to prepare an organic monocrystal thin film. It can be expected that this technique be applied to the production of organic EL devices made of Alq₃. Hitherto, an amorphous state thin film has been used to secure reliability of devices at the sacrifice of electrical characteristics. However, the use of the monocrystal thin film makes it possible to improve the characteristics.

The above has described the present invention. The present invention is not limited to these examples unless any example departs from the scope of the subject matter of the present invention.

What is claimed is:

1. A method for analyzing an organic material per microscopic area, comprising the step of:
evaluating, about a specimen containing the organic material, at least one of a potential and an electric charge state of the organic material in an analysis area having a size equivalent to or smaller than a monomolecular size of a molecule of the organic material, or an analysis area to be circumscribed by a circle having a diameter of 0.01 to 10 nm.

2. The method according to claim 1, wherein
the specimen has a thin piece shape obtained by being cut out by means of an FIB or a cryomicrotome under a water-free condition.

3. The method according to claim 2, wherein
when the specimen has a damaged portion generated in a cut-out face thereof by being cut out by means of an FIB, the damaged portion is further cut out by means of a cryomicrotome.

4. The method according to claim 2, wherein
the thin piece shape has a thickness from 1 to 300 nm.

5. The method according to claim 1, wherein
the specimen has a structure wherein two or more different materials containing the organic material are laminated, and the specimen is cut out in a direction along which a cross section of a lamination layer of the specimen appears.

6. The method according to claim 1, wherein
the specimen is prepared from an organic EL device or an organic semiconductor device.

7. A method for analyzing an organic material per microscopic area, comprising the steps of:
radiating an electron beam into a specimen containing the organic material, the electron beam having a beam diameter equivalent to or smaller than a monomolecular size of a molecule of the organic material to be measured or an electron beam of 0.01 to 10 nm diameter; and
analyzing the organic material per microscopic area based on electron energy loss data obtained when the electron beam is transmitted through the specimen.

8. The method according to claim 7, wherein
the specimen has a thin piece shape obtained by being cut out by means of an FIB or a cryomicrotome under a water-free condition.

9. The method according to claim 8, wherein
when the specimen has a damaged portion generated in a cut-out face thereof by being cut out by means of an FIB, the damaged portion is further cut out by means of a cryomicrotome.

10. The method according to claim 8, wherein the thin piece shape has a thickness from 1 to 300 nm.

11. The method according to claim 7, wherein
the specimen has a structure wherein two or more different materials containing the organic material are laminated, and the specimen is cut out in a direction along which a cross section of a lamination layer of the specimen appears.

12. The method according to claim 7, wherein
the specimen is prepared from an organic EL device or an organic semiconductor device.

13. The method according to claim 7, wherein
the electron energy loss data are obtained by use of an energy filter type electron microscopic device.

14. The method according to claim 7, wherein
the electron energy loss data are electron energy loss data generated following transition processes between π→π* electron energy levels, or ionization transition processes, which are related to molecular orbitals of the organic material.

15. The method according to claim 7, wherein
the analysis based on the electron energy loss data is analysis of a local electric charge state or an electric charge distribution state of the organic material.

16. The method according to claim 7, wherein
the analysis based on the electron energy loss data is analysis of a local potential or a potential distribution of the organic material.

17. The method according to claim 7, wherein
the analysis based on the electron energy loss data is analysis of a distribution of a characteristic of an interface between the organic material and another material adjacent thereto and a vicinity of the interface.

18. The method according to claim 7, wherein
the analysis based on the electron energy loss data is analysis of difference between energy levels related to a transport of electrons or positive holes in a joint area between different materials containing the organic material.

19. A device for analyzing an organic material per microscopic area, comprising:
a specimen-laying section on which a specimen containing the organic material is laid;
an electron beam radiating section for radiating an electron beam having a beam diameter of 0.01 to 10 nm into the specimen; and
an electron energy loss detecting section for obtaining electron energy loss data when the electron beam is transmitted through the specimen.

20. The device according to claim 19, wherein
an accelerating energy of the electron beam is adjusted within a range of 5 to 1000 keV so as to control a half band width of an energy loss peak generated by transmission of the electron beam through the specimen into a range of 0.02 to 3.0 eV so as to obtain a transition energy value corresponding to the specimen.

21. The device according to claim 19, further comprising:
a specimen heating and cooling system.

22. The device according to claim 19, further comprising:
a molecular orbital method calculating function.
